(19) United States
(12) Patent Application Publication
(10) Pub. No.: US 2014/0361895 A1
(43) Pub. Date: Dec. 11, 2014

(54) ACCESS ALARM

(71) Applicant: Dennis Smith, Oxenford (AU)

(72) Inventor: Dennis Smith, Oxenford (AU)

(21) Appl. No.: 14/297,913

(22) Filed: Jun. 6, 2014

(30) Foreign Application Priority Data
Jun. 7, 2013 (AU) 2013902053

(51) Int. Cl. G08B 21/02; G08B 13/12

(52) U.S. Cl. CPC G08B 21/0261; G08B 13/12
USPC 340/541

(57) ABSTRACT

An alarm system comprises a tripwire having at least one end attached to a detection assembly comprising an elongate shank, a housing supporting the elongate shank, a coil spring mounted on the shank which provides a restoring force to movement of the shank outwardly from the housing, a micro switch operatively associated with the shank and an alarm electrically connected to the micro switch such that tripping of the wire activates the alarm.

This invention relates to an access alarm and is particularly suited for use in relation to fences that surround swimming pools.

Conventional fence alarms can be attached to an existing or new fence and are used mainly for security wherein a sensor cable is attached to the fence and electronically connected to closed circuit television or electronic detection systems. However, such conventional fence alarms described at www.aps.perimeter-security.comp/flexiguard.htm can be very expensive and are not totally suited to providing an appropriate alarm system when toddlers obtain access to swimming pools.

Alarms specifically adapted for swimming pool fences can include infra-red motion detectors that protect an 8 yard semi circular area by emitting a 110-decibel alarm that can be heard up to 50 yards away. These alarms are armed one minute after being switched on and possess a 5 second entry delay feature which prevents the alarm from going off immediately if activated. Features include a movement and heat sensitive sensor that can be activated by a small child or toddler. Such alarms are described at www.safetyalarms.com. However such alarms are relatively expensive and cover only a small area.

Reference may be made to US Patent Publication US2004/0113780 which describes a tripwire warning device which includes a housing, a battery mounted within the housing, an alarm mounted within the housing and a pair of switches mounted on opposed sides of the housing and configured to close a circuit between the alarm and the battery when either switch is activated. Each switch is attached to a tripwire such that a selected tension will activate the alarm. The tripwire is fixedly attached to trees, posts or stakes that may surround or partially surround a perimeter area and the housing interconnects a pair of adjacent tripwires. This conventional warning device is complicated in construction in requiring a pair of switches to interconnect adjacent lengths of tripwire and installation was also time consuming. U.S. Pat. Nos. 4,463,400, 4,533,906, 6,646,563 and 5,392,027 all refer to fence alarms having multiple taut wires or tripwires which are each attached to a plurality of associated detectors. These conventional fence alarms are thus extremely complicated in construction.

U.S. Pat. No. 5,102,103 refers to a child safety fence wherein use is made of a flexible tripwire extending between and slidably supported by multiple posts of a fence. The tripwire is however attached to a top rail of the fence and requires netting attached thereto to prevent entry into a swimming pool surrounded by the fence. This conventional fence alarm system was also complicated in construction.

It is therefore an object of the invention to provide an access alarm including for swimming pools which is simple in construction and effective in operation.

A further object of the invention is to provide a method of use of the access alarm.

In one aspect of the invention there is provided a method of preventing a child from entering a swimming pool or alerting an undesired entry of the child into the swimming pool which includes steps of:
(i) attaching a single tripwire to a fence surrounding the swimming pool closely adjacent to a support surface for the fence and thus does not have any extraneous structure wherein said tripwire is releasably and movably attached to attachment locations on spaced uprights of the fence;
(ii) attaching at least one end of the tripwire to at least one housing containing an alarm wherein said at least one housing is attached to the fence whereby;
(iii) upon movement of the tripwire relative to said spaced uprights and through said attachment locations said alarm is activated.

The invention also provides an alarm system for swimming pools which includes (i) a tripwire having at least one end thereof attached to a hook or eyelet having an elongate shank, and (ii) a bracket located in the housing and attached thereto for supporting the elongate hook or eyelet, (iii) a coil spring mounted to the elongate hook or eyelet providing a bias or restoring force to movement of the hook or eyelet outwardly from the housing; and (iv) a micro switch operatively associated with the hook or eyelet and (v) an alarm electrically connected to the micro switch.

The above alarm system is considered to be very simple in construction and thus distinguishes over the alarm system shown in US2004/0113780 which is complicated in construction using a dual spring switch having alignment folds and a positive contact plate which slide into pull tab notches wherein a variably sensitive pull tab is inserted between a respective upper leaf of the dual spring switch and the positive contact plate. The pull tab must be separated from the housing to close the circuit to activate the alarm.

In relation to the method aspect of the invention the term “does not have any extraneous structure” in step (i) means that the single tripwire does not have structure attached thereto for contact with a child such as the wire netting described in U.S. Pat. No. 5,102,103.

The eyelet or hook having an elongate shank for use in the alarm system of the invention may have a hook in the shape of a J or S or may have an eyelet or round part which is circular, polygonal or any other shape such as rectangular or square.

The shank of the hook or eyelet may be screw threaded to receive an attachment nut or other fastener to a movable contact of the micro switch. The restoring coil spring may be wound around the elongate shank and be retained in desired position by the attachment nut and the bracket which may be L-shaped or W-shaped or other suitable shape which is bolted to an internal surface of the housing. The attachment nut may regulate the tension of the coil spring.

The micro switch used in the alarm system of the invention may be of conventional type as described in for example australia.rs-online.com. However, the micro switch may have at least one movable contact to open or close a circuit which only requires a very small movement.

The housing may be of any suitable shape such as cubical or cylindrical.

Reference may now be made to a preferred embodiment of the invention as shown in the attached drawings wherein:

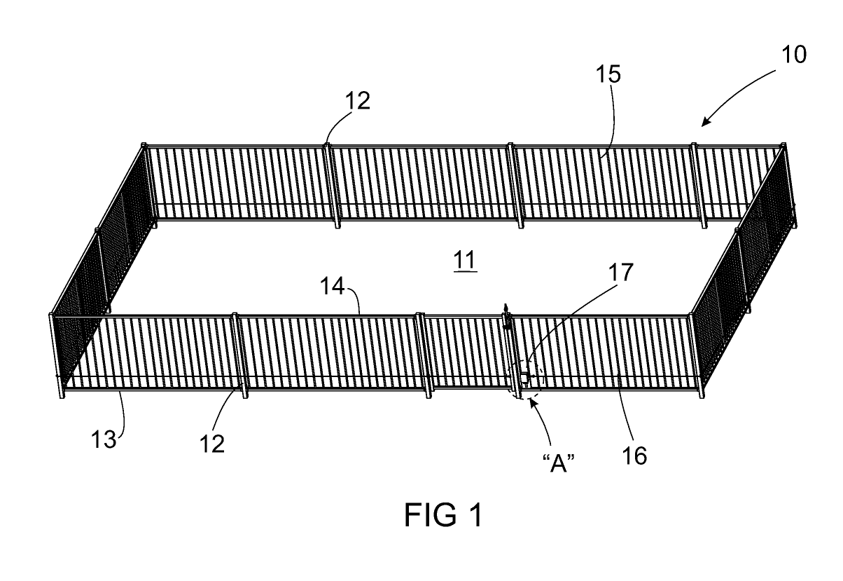

FIG. 1 is a perspective view of a swimming pool surrounded by a fence which is fitted with the alarm system of the invention;

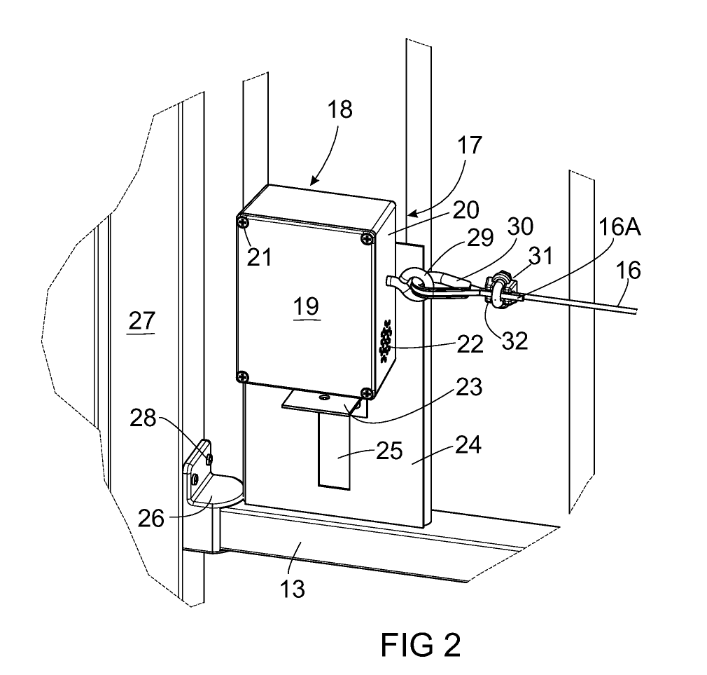

FIG. 2 is a detail of area “A” shown in FIG. 1;

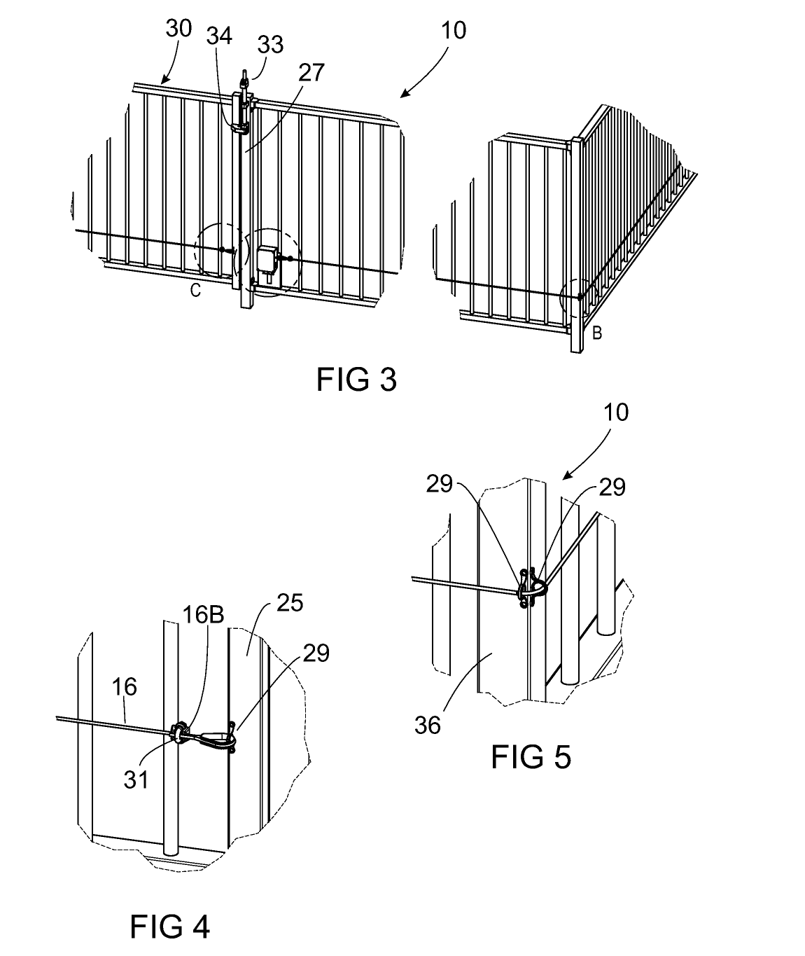

FIG. 3 is a partial view of the fence shown in FIG. 1 showing locations “B” and “C”;

FIG. 4 is a detail of location “C” shown in FIG. 3;

FIG. 5 is a detail of location “B” shown in FIG. 3;

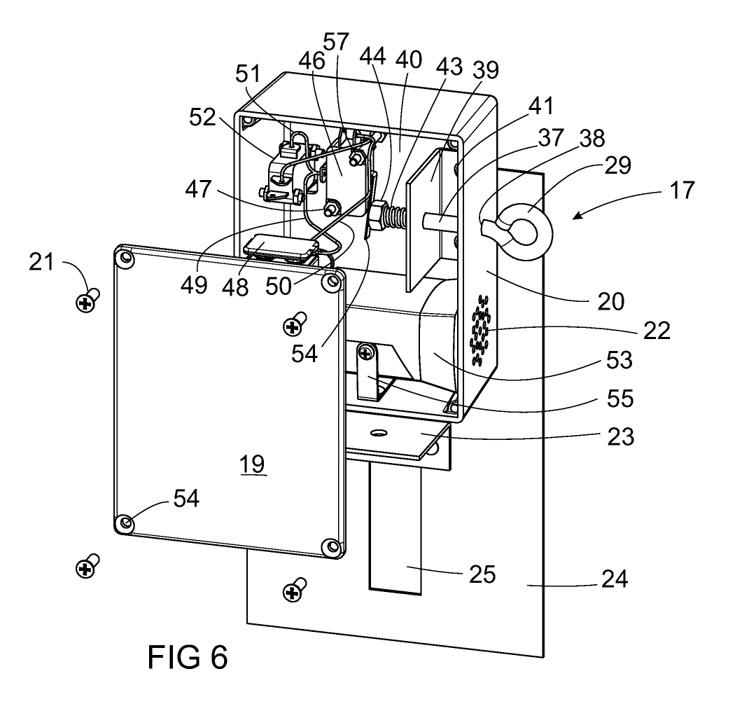

FIG. 6 is a perspective view of the detection assembly used in the alarm system of the invention with a front plate removed for convenience;

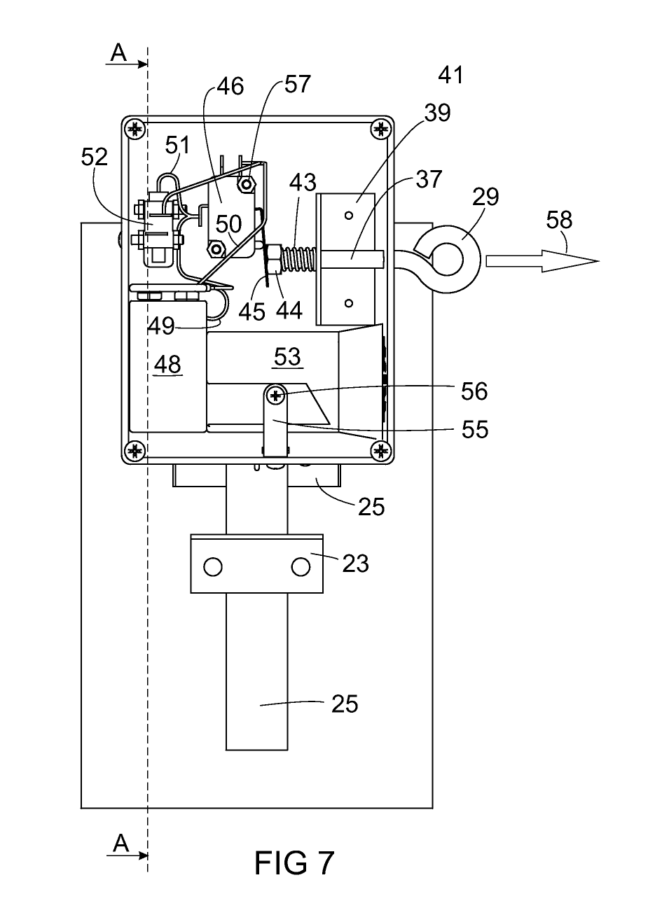

FIG. 7 is a rear view of the detection assembly shown in FIG. 6;

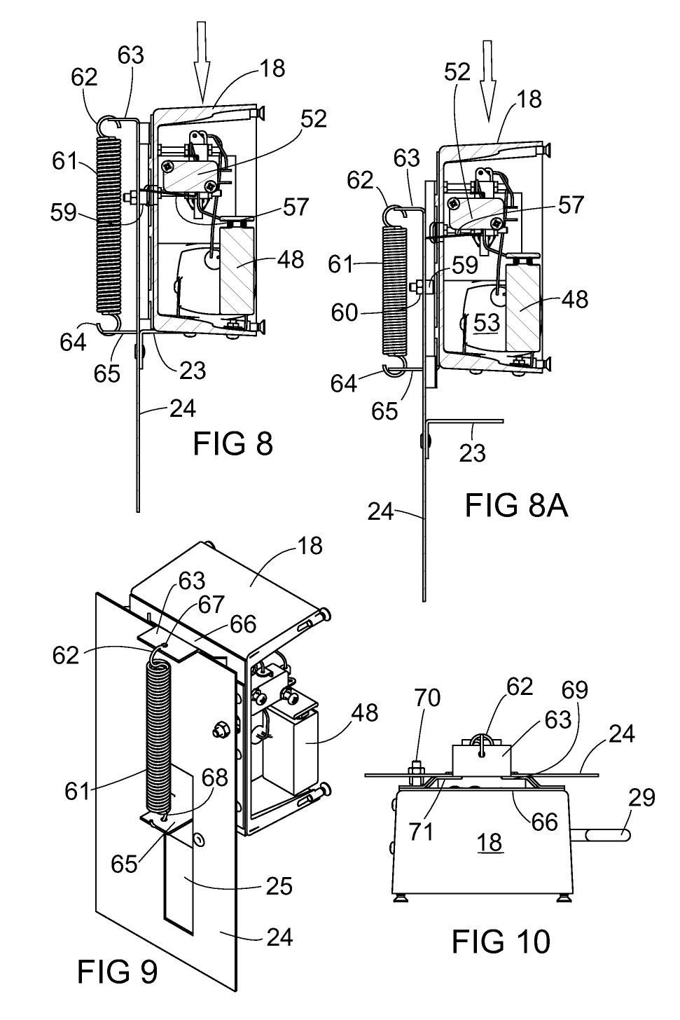

FIG. 8 is a sectional view along line A-A of FIG. 7 showing a micro switch in a closed position upon downward movement of the detector assembly;

FIG. 8A is a similar view to FIG. 8 showing the micro switch in an open position;

FIG. 9 is a rear perspective view of the detection system shown in FIG. 6;

FIG. 10 is a plan view of the detection system shown in FIG. 9;

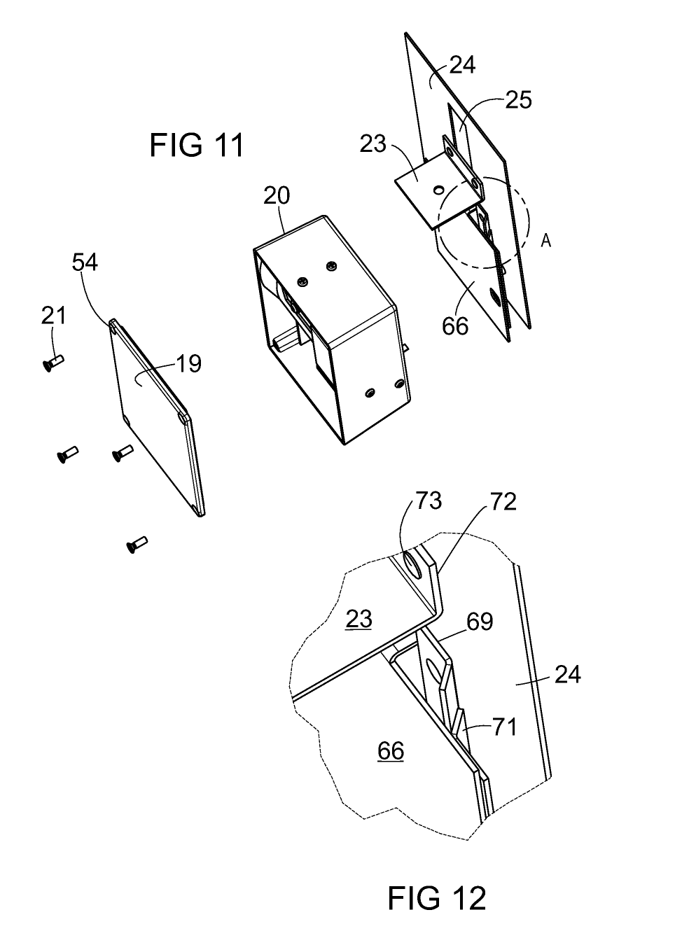

FIG. 11 is an exploded perspective view of the detection assembly shown in FIG. 6 from an underside thereof;

FIG. 12 is a detail of location “A” shown in FIG. 11;

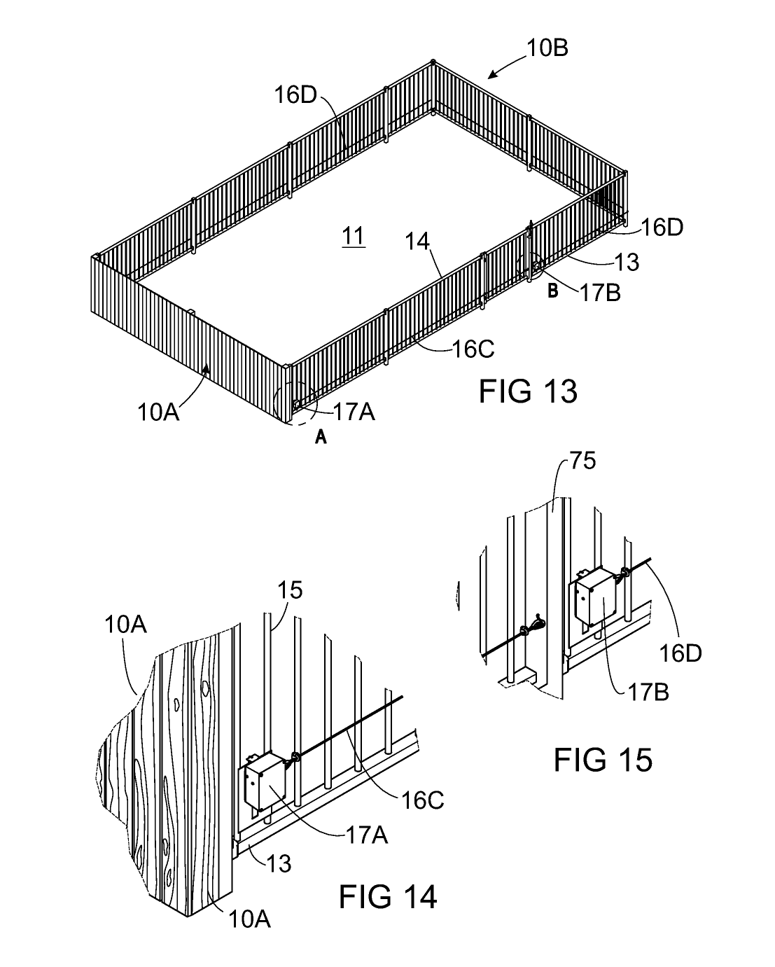

FIG. 13 is a similar view to FIG. 1 showing another embodiment of the invention;

FIG. 14 is a detail of location “A” shown in FIG. 13;

FIG. 15 is a detail of location “B” shown in FIG. 13; and

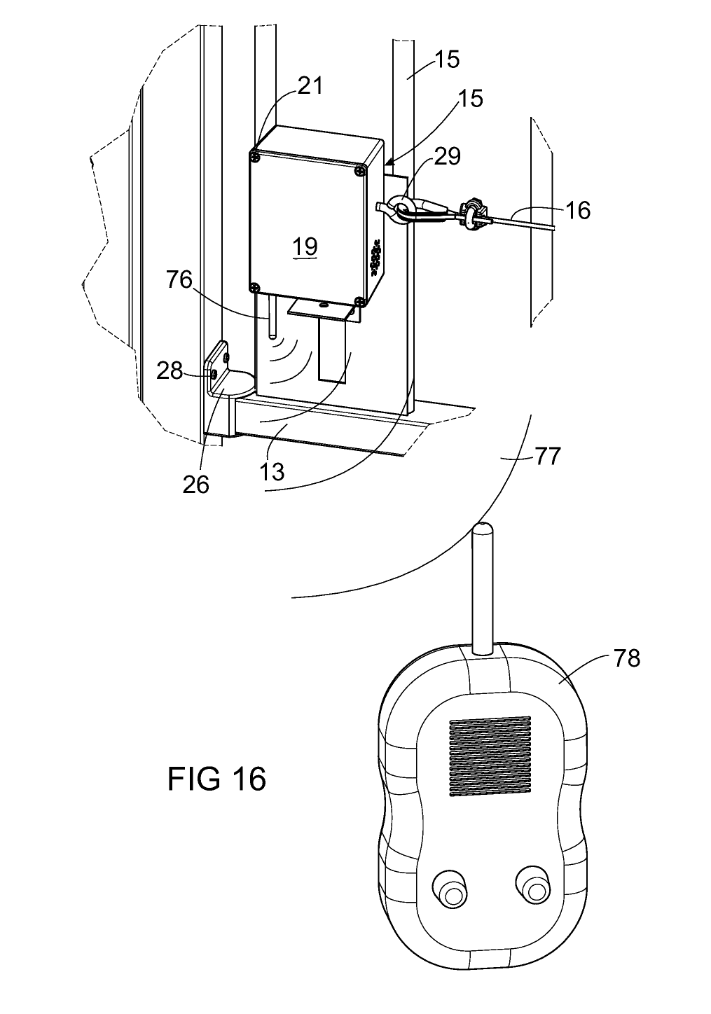

FIG. 16 is a perspective view of a transmitter used in the alarm system of the invention.

In FIG. 1 there is shown a swimming pool fence 10 surrounding an area 11 occupied by a swimming pool (not shown). The fence 10 has a plurality of posts 12 which are embedded in the ground as well as a bottom horizontal rail 13 and top horizontal rail 14. There is also shown a plurality of uprights 15 interconnecting bottom horizontal rail 13 and top horizontal rail 14. There is also shown a tripwire 16 located adjacent to bottom horizontal rail 13 which upon any movement is detected by detection assembly 17.

As shown in FIG. 2 detection system 17 includes a housing 18 having a front plate 19 connected to a rectangular casing 20 by fasteners 21 in the form of screws. The housing 19 is also provided with apertures 22 and the housing 19 is supported by a stop member 23. There is also provided rear plate 24 having slot 25. There is also provided bracket 26 interconnecting bottom horizontal rail 13 and stationery gate post 27 by fasteners 28.

There is also shown tripwire 16 connected to eyelet 29 which is attached to housing 18. Tripwire 16 also extends through thimble or sleeve 30 and wire clamp 31 having u shaped member 32 through which end 16A of tripwire 16 extends.

In FIG. 3 there is shown a closure member 33 for gate 30 adjacent gate post 27. There is also shown gate stop 34.

In FIG. 4 there is shown one end 16B of tripwire 16 attached to eyelet 29 attached to movable post 35 of gate 30 and also extending through clamp 31.

In FIG. 5 there is shown tripwire 16 extending through a pair of adjacent eyelets 29 attached to corner post 36 of fence 10.

In FIG. 6 there is shown detection system 17 in greater detail showing eyelet 29 having a shank 37 which extends through aperture 38 of casing 20 and which also extends through L shaped plate or bracket 39 which is attached to internal surface 40 of casing 20 by fasteners 41. The shank 37 extends through aperture 42 of L shaped support plate 39 and is provided with a restoring spring 43 located adjacent to nut 44 which is mounted on a threaded part of shank 37. Nut 44 attaches shank 37 to movable contact 45 of micro switch 45. Micro switch 46 is attached to internal surface 40 by fasteners 47. There is also provided battery 48 and conductor or wire 49 electrically connecting battery 48 to micro switch 46. There is also provided earth wire 50 as well as wire 51 electrically connecting micro switch 46 to another micro switch 52. There is also shown siren 53 electrically connected to battery 48. Fasteners 21 have associated apertures 54 and bracket 55 and associated fasteners 56 support siren 53 in housing 18. There is also provided a movable contact 57 of micro switch 52.

In FIG. 7 there is shown arrow 58 that means that when tripwire 16 is pulled in the direction of the arrow 58 against the bias of spring 43 that movable contact 45 closes a circuit with battery 48 and siren 53 to activate siren 53 when a child is attempting to obtain access to swimming pool 11 by contacting tripwire 16.

In FIG. 8 there is shown movable contact 57 of micro switch 52 in contact with stationary contact 59 which is attached to rear plate 24 of housing 18 by fastener 60. This occurs upon downward movement of housing 18 caused by a person's foot for example contacting housing 18. This downward movement of housing 18 is against the bias of vertical spring 61 having one end 62 in contact with adjacent end or flange 63 of stationary rear plate 24. The other end 64 of spring 61 engages with flange 65 of movable plate 66 attached to housing 18.

In FIG. 8A there is shown movable contact 57 of micro switch 52 in the open position spaced from stationary contact 59 of plate 24 before downward movement of housing 18.

In FIG. 9 it will be appreciated that spring 61 is retained in aperture 67 of flange 63 and aperture 68 of flange 65 respectively.

In FIGS. 10-11 there are shown stationary slides or guides 69 attached to plate 24 which engage with movable slides or guides 71 attached to movable plate 66. Stop 23 has attachment flange 72 and attachment apertures 73 for attachment to plate 24.

In FIGS. 13-15 there is shown another type of fence to which the alarm system 10A of the invention may be attached. In this embodiment there may be provided a wooden fence 10A and a metal fence 10B which has tripwires 16C and 16D attached to a bottom part thereof adjacent to and above bottom horizontal rail 13. In this embodiment and as shown in FIG. 15 detection assembly 17B is attached to vertical rails 15 above horizontal rail 13 so that tripwire 16D has one end terminating in detection assembly 17B being attached to eyelet 29 shown previously adjacent movable gate post 75. A further detection assembly 17A may be attached to fence 10B adjacent wooden fence 10A and tripwire 16C extends up to gate post 75 as shown in FIG. 13.

In FIG. 16 it will be appreciated that housing 18 may be fitted with an antenna 76 so that when activated a signal represented by curved lines 77 may be forwarded to transmitter 78.

While the invention has described the use of a siren as a suitable alarm, it will be appreciated that other alarms can be used such as activation of a spot light, a flashing light or a buzzer. The transmitter may be activated by RF, wireless or any other suitable type of signal.

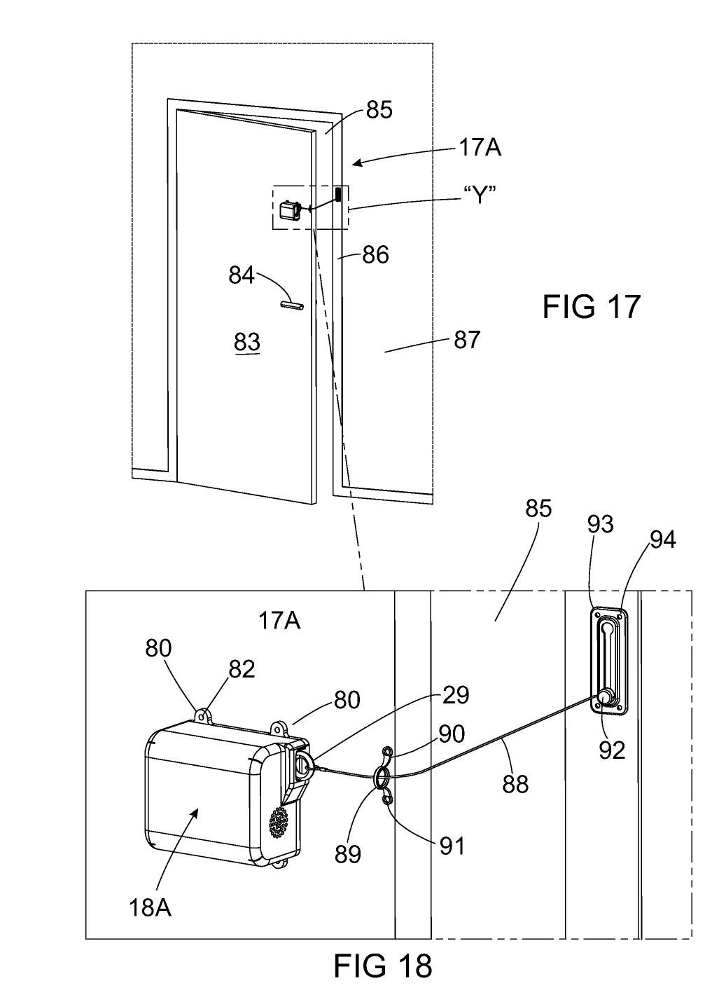

Reference may be made to another embodiment of the invention as shown in FIGS. 17-31 wherein:

FIG. 17 is a perspective view showing the alarm of the invention used as a door alarm when the door is open;

FIG. 18 shows a detailed perspective view of section “Y” shown in FIG. 17;

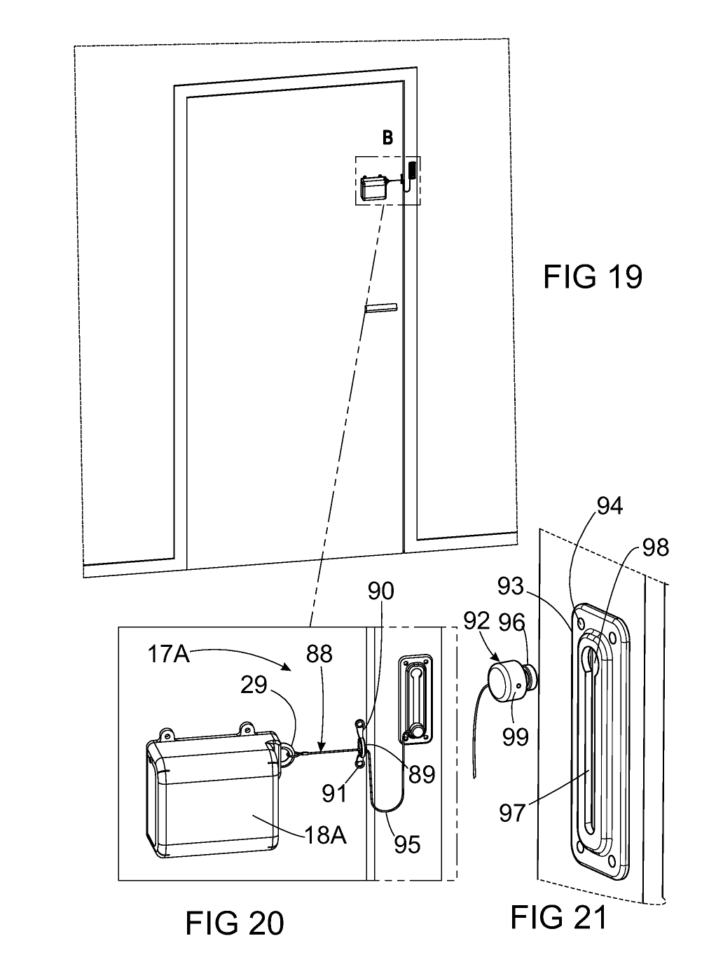

FIG. 19 shows a similar view to FIG. 17 but showing the situation when the door is shut;

FIG. 20 shows a detailed view of section “B” shown in FIG. 19;

FIG. 21 shows a further detailed perspective view of the connection between the alarm housing and the door latch;

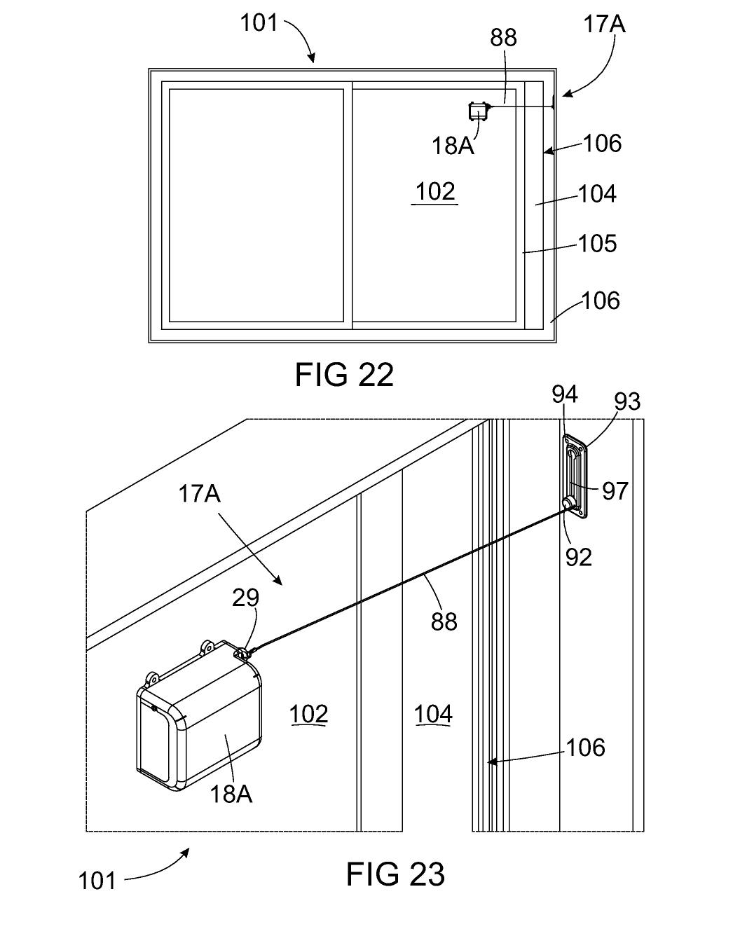

FIG. 22 shows the alarm of the invention when used as a window alarm;

FIG. 23 shows a more detailed view of the operation of the alarm than shown in FIG. 22;

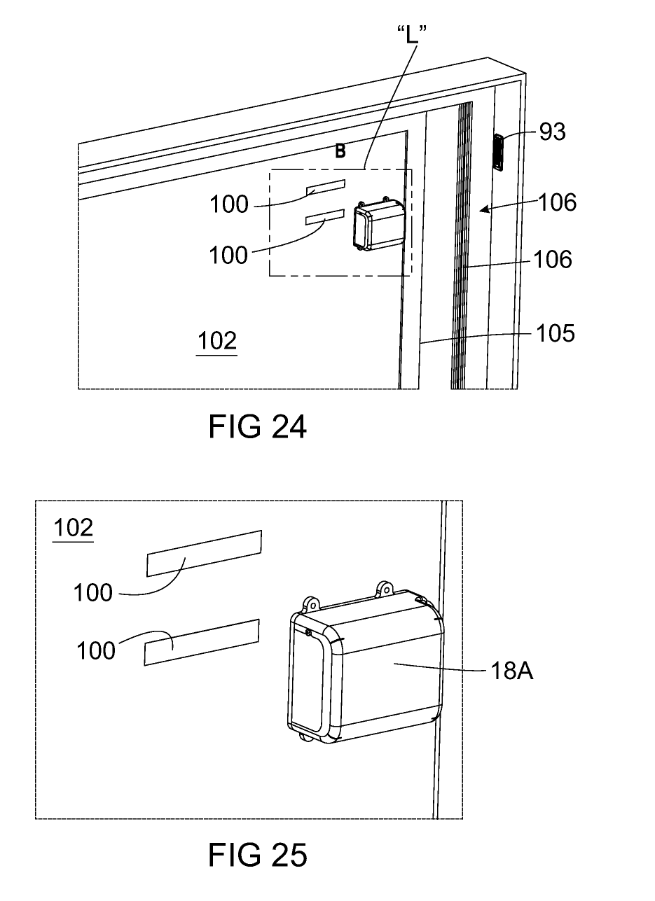

FIG. 24 shows the attachment of the alarm housing to the window;

FIG. 25 shows a detail of section “L” shown in FIG. 24;

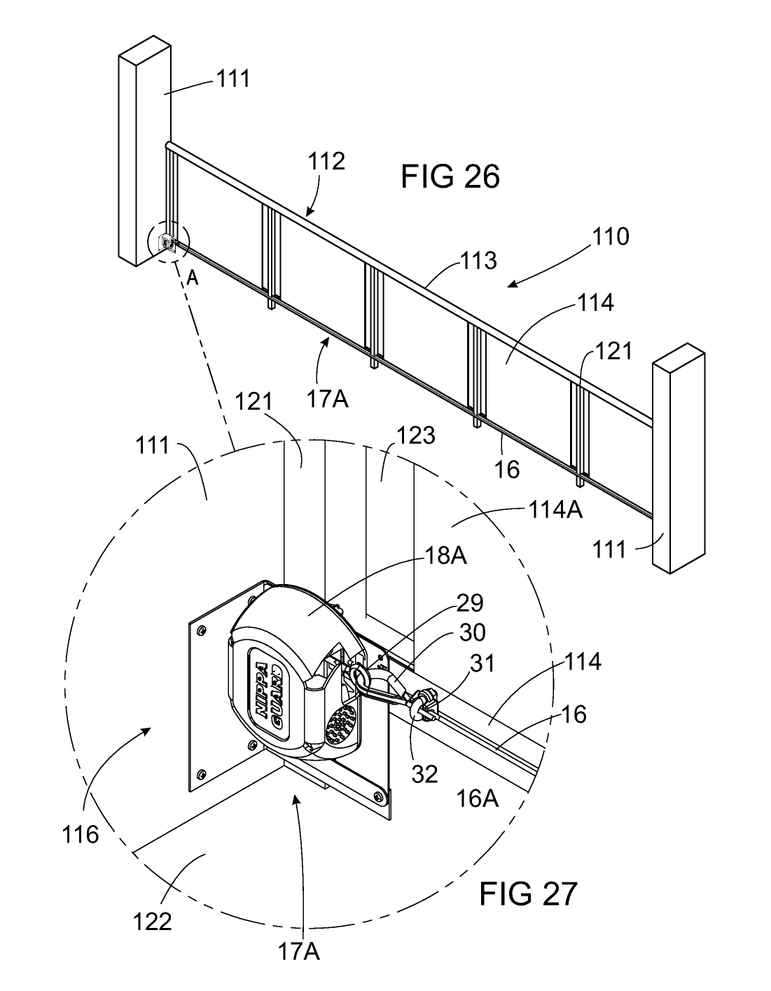

FIG. 26 shows the alarm of the invention when used in connection with a balustrade;

FIG. 27 shows a detail of section “A” shown in FIG. 26;

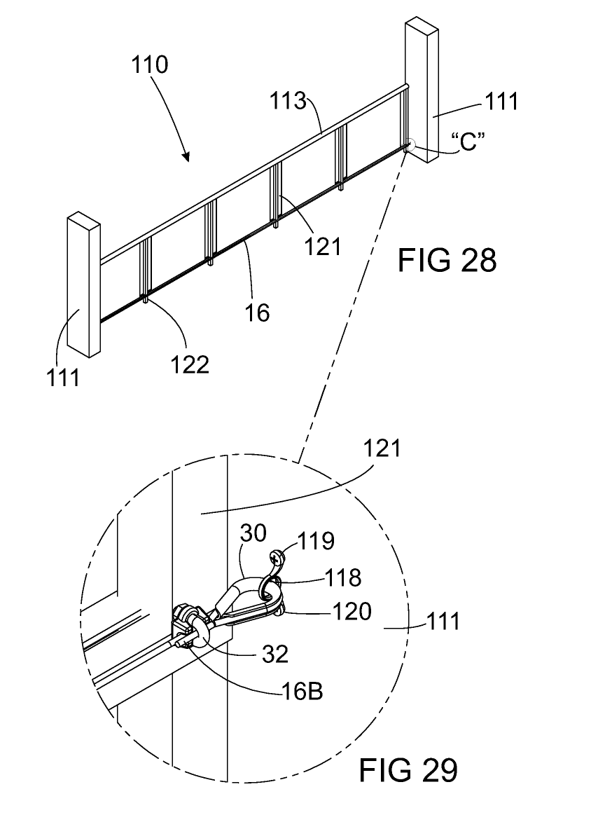

FIG. 28 shows the connection of the tripwire to one end of the balustrade which does not incorporate the alarm;

FIG. 29 shows a detail of section “C” shown in FIG. 28;

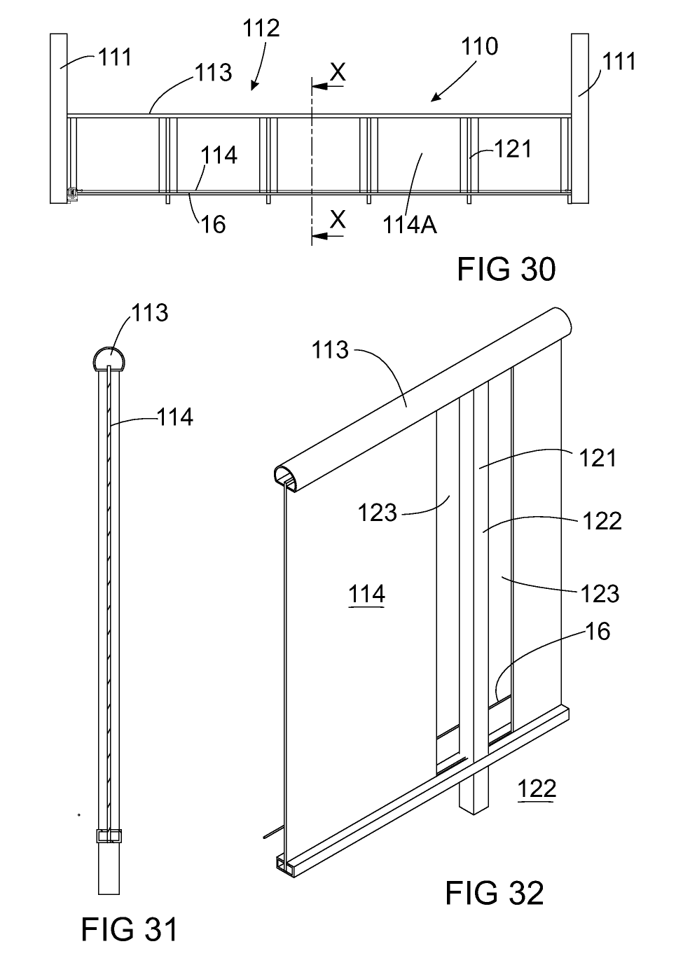

FIG. 30 is a front view of the balustrade shown in FIG. 26;

FIGS. 31-32 are a sectional view of the balustrade shown in FIG. 26 through line “X-X” and detailed perspective view respectively; and

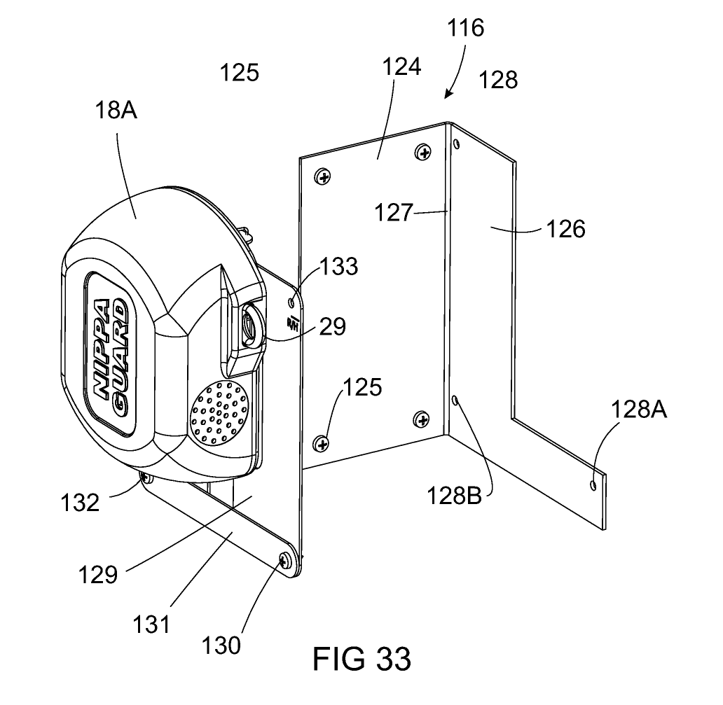

FIG. 33 shows the connection of the alarm housing to both an end column and to the balustrade.

In FIGS. 17-18 there is shown a detection system 17A having an alarm housing 18A attached by fasteners (not shown) extending through brackets or sockets 80 having attachment apertures 82 to a door 83 having a door handle 84. The door 83 is shown in a slightly open state or is ajar as there is a space 85 between door 83 and door frame 86 adjacent wall 87. As best shown in FIG. 18 alarm housing 18A has an eyelet 29 which is attached to a cable 88 or other suitable line member such as a cord which extends through a fixed eyelet 89 attached to door 83 by fasteners (not shown) extending through upper and lower brackets 90 each having attachment apertures 91. The cable 88 is then attached to a catch 92 which is engageable with a slide 93 attached to doorframe 86 by fasteners (not shown) extending through attachment apertures 94.

FIGS. 19-20 show the door 83 now closed and in this situation cable 88 is shown in a loose or slack state having a slack part 95. FIG. 21 shows that catch 92 can be easily released from slide 93 and has an end part or retainer 96 which engages in elongate slot 97 of slide 93. Slide 93 also has top opening or recess 98 which engages with body part 99 of catch 92.

It will be appreciated from FIGS. 19-20 that when door 83 is shut that alarm 18A is not activated. However, as soon as cord 88 is made taut as shown in FIGS. 17-19, cable 88 then pulls on eyelet 29 as shown in FIG. 7 thereby activating the alarm 18A.

FIGS. 22-25 show the operation of the detection system 17A to a window assembly 101 and it will be noted that housing 18A is attached to a glass window panel 102 by double sided tape 100 shown in FIG. 24-25. There is also shown cable or cord 88 attached to eyelet 29, and FIGS. 22-25 show window pane 102 spaced from window frame 103 by space 104. The alarm 18A will be activated as soon as movement of window pane 102 occurs as cable 88 will then pull on eyelet 29 causing activation of the alarm as shown in FIG. 7. FIG. 23 shows cable 88 in a taut condition causing activation of the alarm. There is also shown window frame 105 and fixed extrusion 106. Space 104 and space 85 may be of the order of 100 mm. As soon as cable 88 reaches a slack state and window pane 102 is shut the alarm 18A will be deactivated.

FIGS. 26-27 show the detection system 17A used in connection with a balustrade 110 which has a pair of end posts or columns 111 and fence part 112 having an upper rail 113 and lower rail 114. The fence part 112 may also include wall panels 114 formed of glass or other suitable transparent plastics material between each post 121.

The detection system 17A shows alarm housing 18A attached to an adjacent surface of column 111 by a bracket assembly 116 shown in more detail in FIG. 33. In FIG. 27 there is shown a tripwire 16 which extends through thimble or sleeve 30 and wire clamp 31 having U shaped member 32 through which end 16A of tripwire extends as shown in FIG. 2.

FIG. 28-29 show the other end 16B of tripwire 16 connected to a wire clamp 31 and U shaped member 32 as shown in FIG. 2. Tripwire 16 extends through thimble or sleeve 30 which is looped around retaining bracket 118 attached to column 111 at 119 and 120. Balustrade 110 has posts 121 extending into the ground or support surface 122.

In FIGS. 30-32 there is shown balustrade 110 which also includes spaces 123 between each panel 114 and each post 121. Tripwire 116 extends between each column or pillar 111 and it will be appreciated that by stepping on tripwire 16 this will result in activation of the alarm 18A included in detection system 17A. Also an intruder stepping on alarm housing 18A will also result in activation of the alarm because it will result in movement of eyelet 29.

In FIG. 33 there is shown housing 18A having a backing plate 129 with a reinforcement strap 131 carrying fasteners 130 and 132. There is also provided a bracket assembly 116 having plate 124 which has screws 125 that attaches plate 124 directly to pillar or column 111. There is also provided L shaped plate 126 integral with plate 124 at 127 whereby fasteners 130 and 132 attach backing plate 129 directly to plate 126 with fasteners 130 and 132 extending through attachment apertures 128A and 128B. There is also another fastener (not shown) that attaches backing plate 129 to plate 126 by engaging with attachment apertures 128. Bracket assembly 116 is spaced from balustrade 110 as shown in FIG. 27.

From the foregoing it will be evident that the scope of the invention can be broadened to cover attachment of the tripwire to a balustrade and the term “tripwire” can be broadened to cover use of a cable or cord and wherein the alarm system of the invention can be used as a door alarm or window alarm.

The line member may be a cable, cord, string or other suitable flexible length of elongate material.

The alarm may be suitably releasably attached to a door or window by fasteners or adhesive or may be attached to a fixed support or to a wall adjacent the door or window.

The fixed support referred to above may be adjacent the door or window such as a door frame or window frame or wall. In the case of the fence or balustrade the alarm may be attached to the balustrade or fence or to the fixed support adjacent the fence or balustrade.

In another aspect the invention may provide an alarm system for doors, windows, fences or balustrades which includes: (a) a line member having at least one end thereof attached to a hook, eyelet or other movable connection of an alarm; (b) a spring or other biasing member mounted to the hook, eyelet or other movable connection which produces a bias or restoring force to movement of the hook, eyelet or other movable connection; (c) a micro switch operatively associated with the hook, eyelet or other movable connection; and (d) an alarm operatively associated with the micro switch.

Therefore the method of the invention can be broadened to include the following steps:
(i) attaching an alarm to a door, window, balustrade or fence;
(ii) attaching one end of a line member not having any extraneous structure to a movable component of the alarm;
(iii) attaching another end of the line member to a location spaced from the alarm wherein said another end is releasably and movably connected to a suitable support at said location; and
(iv) whereby upon undesired or unauthorized entry through the door or window, balustrade or fence, said line member by moved by said undesired or unauthorized entry to activate the alarm.

In this regard the alarm is suitably the alarm of the invention and the movable component may be a hook, eyelet or connection for the line member which may be movable against the bias of a spring which returns the hook, eyelet or connection to an equilibrium or unbiased state when the line member is returned from a taut to a loose or slack condition.

It will be realized that the foregoing has been given by way of illustrative example only and that all other modifications and variations as would be apparent to persons skilled in the art are deemed to fall within the broad scope and ambit of the invention as herein set forth. Throughout the description and claims to this specification the word “comprise” and variation of that word such as “comprises ” and “comprising” are not intended to exclude other additives components integers or steps.

1. An alarm system comprising a tripwire having at least one end attached to a detection assembly comprising an elongate shank, a housing supporting the elongate shank, a coil spring mounted on the shank which provides a restoring force to movement of the shank outwardly from the housing, a micro switch operatively associated with the shank and an alarm electrically connected to the micro switch such that tripping of the wire activates the alarm.

2. The alarm system of claim 1 in which the elongate shank has an eyelet for attachment of the tripwire.

3. The alarm system of claim 1 in which the shank is screw threaded to receive a nut attaching a contact for the micro switch and the coil spring is wound around the shank and retained in position by the said nut and a bracket fixed to an internal surface of the housing.

4. The alarm system of claim 3 in which adjustment of the nut regulates the tension of the coil spring.

5. The alarm system of claim 1 in which the micro switch has at least one movable contact to open or close the switch.

6. The alarm system of claim 1 in which the detection assembly has a transmitter which transmits an alarm signal to a remote receiver.

7. The alarm system of claim 1 applied to a pool fence with a gate in which the tripwire is slidably mounted on the lower outside of the fence and the detection assembly is mounted on the gate.

8. The alarm system of claim 1 applied to a door in which the tripwire is releasably attached to the door jam and the detection assembly is mounted on the door.

9. The alarm system of claim 1 applied to a window in which the tripwire is releasably attached to the window frame and the detection assembly is mounted on the window.

10. The alarm system of claim 1 applied to a window in which the tripwire is releasably attached to the window and the detection assembly is mounted on the window sill.

11. A method for alerting the entry of a child through a security fence to a swimming pool including the steps of:
(i) attaching a trip wire to the fence
(ii) attaching at least one end of the tripwire to a detection assembly containing an alarm which is attached to a gate in the fence whereby;
(iii) upon movement of the tripwire said alarm is activated.
